(19) United States
(12) Patent Application Publication
(10) Pub. No.: US 2013/0034613 A1
(43) Pub. Date: Feb. 7, 2013

(54) FORMULATIONS OF PHOSPHITES

(71) Applicants: Cornelis Johannes Kok, Elst (NL); Wilhelmus Maria Van Der Krieken, Wageningen (NL)

(72) Inventors: Cornelis Johannes Kok, Elst (NL); Wilhelmus Maria Van Der Krieken, Wageningen (NL)

(73) Assignee: Ceradis B.V., Wageningen (NL)

(21) Appl. No.: 13/512,318

(22) PCT Filed: Nov. 29, 2010
(86) PCT No.: PCT/NL10/50800

§ 371 Date: Sep. 18, 2012

(30) Foreign Application Priority Data
Nov. 27, 2009 (EP) 09177389.5

(51) Int. Cl. A01N 59/26; C05G 3/00; A01P 3/00

(52) U.S. Cl. 424/601; 71/23

(57) ABSTRACT

The invention relates to a composition comprising a phosphite compound, a lignin compound and a pesticide adjuvant. The invention further relates to the use of the composition of the invention, and to methods of reducing the phytotoxicity of a composition comprising a phosphite compound and an adjuvant. The invention also relates to a method for protecting an agricultural plant from a plant disease comprising applying to said agricultural plant a composition according to the invention.

### FIELD

The present invention discloses formulations for phosphite compositions with optimized properties.

Phosphites, or phosphonates are compounds derived of phosphorous acid, H3PO3. In agriculture, phosphites are marketed as fertilizers and as fungicides (e.g. the products TKO PHOSPHITE™, a liquid solution of phosphorus and potassium (Growth Products, USA), ELE-MAX® Foliar Phosphite, a liquid solution of phosphorus and potassium (Helena Chemical Company, USA), ALUDE™, a liquid solution containing mono- and di-potassium salts of phosphorous acid (Cleary Chemicals LLC, USA) and VITAL®, a soluble liquid formulation containing potassium phosphite (Luxembourg-Pamol, Inc., USA). Phosphites are known as environmental benign fungicides with a low toxicity towards users and consumers.

The activity of phosphites as anti-fungal agent depends on a direct toxicity towards oomycetes like Phytophthora and Pythium and a stimulation of plant defense (Smillie, R., Grant, B. R., Guest, D. (1989). Phytopathology 79: 921-926; Daniel, R., Guest, D. (2006). Physiol. Mol. Plant. Pathol. 67: 194-201). To achieve an adequate control of plant diseases by phosphites, a sufficiently high concentration of phosphite in the plant tissue needs to be reached, which can only be attained by applying a rather high dose of phosphite (Pilbeam, R. A., Colquhoun, I. J., Shearer, B., Hardy, G. E. St J. (2000). Australasian Plant Pathology 29: 86-95; Pajor, E., Le Corre, D., and Silué, D. (2001). European Journal of Plant Pathology 107: 861-869).

Due to the high dose necessary for a sufficient activity of phosphites, damage to the host plants (phytotoxicity) is a problem of application of phosphites (Pilbeam, R. A., Colquhoun, I. J., Shearer, B., Hardy, G. E. St J. (2000). Australasian Plant Pathology 29: 86-95; Barrett, S. R., Shearer, B. L., Hardy, G. E. St J. (2004). Australasian Plant Pathology 33: 521-528). Combinations of phosphite products with adjuvants that can enhance the efficacy of pesticide application, such as spreaders and wetting agents, are generally discouraged, because of stimulation of phosphite phytotoxicity by these adjuvants (Schilder, A. (2007). Integrated Pest Management Resource, Michigan State University; Whiley, A. W., Leonardi, J., Pegg, K. G. and Langdon, P. W. (2001). In: Proceedings of the Australian and New Zealand Avocado Growers' Conference ‘Vision 2002’. Australian Avocado Growers' Federation, Brisbane, Session 6/15, 13 pp.; Growth Products USA: Technical data sheet for TKO PHOSPHITE®; Helena Chemical Company USA: Supplemental label ELE-MAX® foliar phosphite).

Generally, pesticide adjuvants are used to optimize the efficacy of pesticides. The group of spreaders, wetting agents and penetrant adjuvants helps to optimize the behavior of the pesticide spray on the hydrophobic wax layer of the leaf surface and also helps the active ingredients of a pesticide to penetrate the leaf. This will lead to a higher deposition and for retention of the pesticide on the plant and, therefore, a higher efficacy of the pesticide (e.g. Ryckaert, B., Spanoghe, P., Haesaert, G., Heremans, B., Isebaert, S. and Steurbaut, W., (2007). Crop Protection 26 1589-1594).

The fact that phosphites cannot readily be used in combination with adjuvants, especially spreaders, wetting agents and penetrant compounds, reduces the potential efficacy of phosphite products. The limitation of the use of adjuvants in combination with phosphites also limits the possibilities of combining phosphite products in tank mixes with many other pesticides that can contain phytotoxicity-enhancing adjuvants.

From this it is clear that there is a demand for a new formulation for phosphite products, allowing the use of phosphites in combination with spreader/wetting agent type adjuvants.

The present invention discloses a formulation that allows the use of phosphites in combination with surfactant type adjuvants, thus avoiding problems with phytotoxicity.

Therefore, the invention provides a composition, preferably a fungicidal or plant fertilizing composition, comprising a phosphite compound, a lignin compound and a surfactant-based pesticide adjuvant, whereby the amount of a lignin compound is more than 15% (w/w).

The presence of a lignin compound was surprisingly found to reduce the phytotoxicity of the phosphite compound in a combination with the surfactant-based pesticide adjuvant.

A typical composition according to the invention will contain at least a suitable source of phosphite, a suitable surfactant-based pesticide adjuvant and a suitable type of lignin compound. The presence of a lignin compound reduces or neutralizes the enhanced phytotoxicity that occurs when phosphite is combined with a pesticide adjuvant.

Compositions comprising phosphite and a lignin compound are known in the art, e.g. from WO2009/082206. However, the described compositions do not comprise a pesticide adjuvant. In addition, these documents do not describe that a lignin compound reduces the phytotoxicity of a combination of phosphite and a pesticide adjuvant.

The term “fungicidal composition” as used in this invention is a composition that inhibits or kills fungi or fungal spores. A fungicidal composition is used to fight fungal infections in animals and in agriculture.

The term “plant fertilizing composition” refers to a composition that can be applied to plants and is able to promote plant and fruit growth. Fertilizers are usually applied either through the soil (for uptake by plant roots) or by foliar feeding (for uptake through leaves).

A composition according to this invention can be a dry powder, a tablet, a suspension, a granule, a paste, a soluble (liquid), a dust, and an emulsion. A preferred composition is a suspension.

As used herein, the term “phosphite compound” is to be understood as a compound derived from phosphorous acid, H3PO3, comprising potassium phosphites such as KH2PO3 and K2HPO3, sodium phosphites, ammonium phosphites, ethyl hydrogen phosphonate, fosethyl-aluminium complexes, phosphorous acid or its alkali metal or alkali earth metal salts, or mixtures of these compounds. A mixture of e.g. NaH2PO3 and Na2HPO3 can easily be obtained by e.g. adding NaOH or Na2CO3 to a final pH of 5.0-6.0 to a H3PO3 solution. The term “phosphite compound” also includes precursor-type compounds which are metabolized in the plant into phosphite compounds and can also be used in a composition of the present invention. Examples of such precursor-type compounds are alkyl esters of phosphoric acid.

The term “lignin-compound” refers to a chemical compound that derived from naturally occurring lignin or lignen. Lignin is a cross-linked racemic macromolecule with molecular masses in excess of 10,000 u. It is relatively hydrophobic and aromatic in nature.

Suitable types of lignin compounds comprise Kraft lignins, organosolv lignins and lignosulfonates.

As used herein, the phrase “Kraft lignins” is to be understood as polyphenolic products from the Kraft pulping process and their derivatives obtained by oxidation or other chemical modification.

As used herein, the phrase “organosolv lignins” is to be understood as polyphenolic products from delignification processes using organic solvents, and their chemical derivatives.

As used herein, lignosulfonates (also termed lignosulphonates, lignosulfate, lignin sulfonate, ligninsulfonate, ligninsulfonic acid, lignosulfonic acid, lignosulfuric acid, or LST 7) are to be understood as water soluble anionic polymers which can be formed as by-products in the sulphite pulping process. Lignosulfonates have generally a wide molecular weight distribution, typically in the range of about 500 to about 150,000. Lignosulfonates may comprise different metal or ammonium ions as counter cations of the sulfonate groups such as, for example, copper, zinc, calcium, sodium, potassium, magnesium and aluminium.

Suitable examples of lignosulfonates comprise sodium lignosulfonate (e.g. sold as BORRESPERSE NA®, Borregaard LignoTech Ltd, Germany); calcium lignosulfonate (e.g. sold as BORRESPERSE CA®, Borregaard LignoTech Ltd, Germany), ammonium lignosulfonate, potassium lignosulfonate, modified lignosulfonate, derivatives of lignosulfonate, or mixtures thereof. Modified lignosulfonates, and derivatives of lignosulfonates are described in U.S. Pat. Nos. 3,639,263, 3,923,532, 4,006,779, 4,017,475, 4,019,995, 4,069,217, 4,088,640, 4,133,385, 4,181,652, 4,186,242, 4,196,777, 4,219,471, 4,236,579, 4,249,606, 4,250,088, 4,267,886, 4,269,270, 4,293,342, 4,336,189, 4,344,487, 4,594,168, 4,666,522, 4,786,438, 5,032,164, 5,075,402, 5,286,412, 5,401,718, 5,446,133, 5,981,433, 6,420,602, and 7,238,645, which are incorporated herein by reference.

Compositions according to this invention may comprise a mixture of two or more lignin compounds.

A lignin compound was found to effectively reduce the phytotoxicity of the phosphite compound in the presence of pesticide adjuvants. A preferred pesticide adjuvant is a surfactant-based pesticide adjuvant. The term “surfactant” or surface active agent refers to an agent that lowers the surface tension of a liquid, allowing easier spreading of the liquid. A surfactant may in addition lower the interfacial tension between two liquids.

Preferred examples of pesticide adjuvants comprise one of more of a wetting agent such as an organosilicone compound (e.g. the commercial product SILWET® R77, Helena Chemical Company, USA and ZIPPER®, Modify, The Netherlands); an ethoxylated nonyl phenol compound (e.g. SURFONIC® Nonylphenol Ethoxylates, Huntsman, USA); alcohol ethoxylate (e.g. SURFONIC® L-series products, Huntsman, USA, GENAPOL EP 2584®, Clariant, Germany); a spreader like alcohol alcoxylates (e.g. BIODEW®, Plaaskem (Pty) Ltd, South Africa), polyoxyethylene alkyl ether (e.g. SOFTANOL® 50 and SOFTANOL 70, Quaron, Belgium), a mixture of vegetable oil and a surfactant (e.g. Brandt MSO, Brandt, USA) and sulfosuccinate (e.g. EMUSLOGEN SF8®, Clariant, Germany); a spreader/sticker such as alkyl aryl polyoxyethylene glycol (e.g. B-85®, Britz Fertilizers, USA) and alkanolamide surfactant (e.g. COHERE®, Helena chemical Company, USA); and/or a spreader/penetrant such as modified soy lecithin (e.g.PROLEC®, Brandt, USA), citrus oil/borax (e.g. WETCIT®, Plaaskem (Pty) Ltd, South Africa), polyether modified polysiloxane, propylene glycol (e.g. EMPIRIC®, Kalo Inc, USA), an ethoxylated tallow amine (e.g. the product series ETHOMEEN®, Akzo Nobel, The Netherlands), di-octyl sulfosuccinate (commercial product Emulsogen SF8, Clariant, Germany) and a quaternary ammonium surfactant (e.g. commercial product GERONOL CF/PN-20N®, Rhodia, France).

Other suitable compounds are or will be known to a person skilled in the art of pesticide formulation and adjuvants.

A composition according to this invention may also comprise a mixture of two or more pesticide adjuvants.

In a further embodiment the composition may further comprise at least one additional compound selected from the group consisting of a sticking agent a preservative, a stabilizer, an antioxidant, an anti-foam-forming agent, a thickening agent, a further pesticidal agent, a filler, a spray oil, a dispersing agent, and a flow additive.

Examples of sticking agents include, but are not limited to, latex based products like PROLONG® (Holland Fyto B.V., The Netherlands) and BOND® (Loveland Industries Ltd), pinolene/terpene based products like NU-FILM® (Hygrotech Saad) and SPRAY-FAST® (Mandops) and long chain polysaccharides like gellan gum, guar gum and xanthan gum. Alternatively, the sticking agent may be a polymer or co-polymer from a type of polymer such as polyacrylate and polyethylene e.g. NEOCRYL® (DSM, The Netherlands). A composition of the invention may also comprise two or more different sticking agents.

Examples of suitable preservatives include, but are not limited to, weak acid preservatives such as sorbic acid, lactic acid, benzoic acid, propionic acid, citric acid, acetic acid, or an alkali metal or alkali earth metal salt thereof; inorganic acids such as hydrochloric acid; imidazoles such as imazalil or any antifungal compound known in the art as a preservative for food products, crop protection or after harvest treatment of fruits, vegetables or cereals; ethyl parabenzoate; borax; calcium bisulfite; calcium disodium EDTA; dehydroacetic acid; isothiazoles (e.g. KATHON® (Rohm and Haas); and antimicrobials capable of preventing bacterial growth in the composition. A composition of the invention may also comprise two or more different preservatives.

Examples of suitable stabilizers include, but are not limited to, xanthan gum, agar, alginic acid, alginate, calcium lactobionate, carrageenan, gellan gum, and guar gum. A composition of the invention may also comprise two or more different stabilizing agents.

Examples of suitable antioxidants include, but are not limited to, amino acids (e.g. glycine, histidine, tyrosine, tryptophan) and their derivatives, imidazole (e.g. urocanic acid) and derivatives, vitamin C and derivatives (such as ascorbylpalmitate and ascorbyltetraisopalmitate, Mg-ascorbylphosphate, Na-ascorbylphosphate, ascorbyl-acetate), tocopherol and derivates (such as vitamin-E-acetate), mixtures of vitamin E, vitamin A and derivatives (vitamin-A-palmitate and -acetate) as well as coniferyl benzoate, rutinic acid and derivatives, α-glycosylrutin, ferulic acid, furfurylideneglucitol, carnosine, butylhydroxytoluene, butylhydroxyanisole, and trihydroxybutyrophenone. A composition of the invention may also comprise two or more different antioxidants.

Examples of suitable anti-foam forming agents include, but are not limited to, polyethylene glycol 8000, polymethylsiloxane, simethicone octanol, and silicone oils. The composition of the invention may also comprise two or more different anti-foam forming agents.

Examples of suitable thickening agents include, but are not limited to, agar, alginic acid, alginate, carrageenan, gellan gum, xanthan gum, guar gum, acetylated distarch adipate, acetylated oxidised starch, arabinogalactan, ethyl cellulose, methyl cellulose, locust bean gum, starch sodium octenylsuccinate, and triethyl citrate. A composition of the invention may also comprise two or more different thickening agents.

A composition according to the invention may additionally comprise a suitable antifungal compound. Suitable antifungal compounds comprise compounds such as imazalil (Janssen Pharmaceutica NV, Belgium), thiabendazole (e.g. the commercial product TECTO® Flowable SC of Syngenta, USA), benomyl, captan (nonsystemic phthalimide fungicide), prochloraz (N-propyl-N-[2-(2,4,6-trichlorophenoxy)ethyl]imidazole-1-carboxamide), orange oil, d-limonene, thioallophanate (e.g. the commercial product TOPSIN® M Cerexagri Inc) and fluazinam (commercial product: (SHIRLAN® Syngenta, Switzerland). Further suitable antifungal compounds can be found in Gewasbeschermingsgids 2006, Gids voor gewasbescherming in de land- en tuinbouw en het openbaar en particulier groen, Plantenziektenkundige Dienst, 2006, 560 pages, Paperback, Gewasbeschermingsgids—ISSN 1571-201X, Volume 18, which is hereby incorporated by reference.

A composition according to the invention may additionally comprise a suitable pesticidal agent. The term “pesticidal agent” as used in this invention is an agent that controls or kills a “pest”, including parasites such as arthropods, arachnids, triatomes, insects, bugs, flies, lice, fleas, mites, gnats, nits, Chagas, mosquitoes, and ticks, for example. The term “pesticidal agent” includes agents to combat insects, nematodes, mites and bacteria. Examples of such compounds are imidacloprid (commercial product ADMIRE® Bayer), pirimiphos-methyl (commercial product ACTELLIC® Syngenta, Switserland), Pyrethroids (commercial product BAYGON® (Bayer), bifenazate (e.g. Uniroyal), dichlorvos (e.g. Amvac Chemical Corporation), imidacloprid (e.g. Bayer), orange oil, limonene, fenamiphos (e.g. Mobay Chemical Corporation), and oxamyl (e.g. Dupont).

Examples of suitable fillers include, but are not limited to, montmorillonite, kaolin, magnesium aluminium silicate (commercial product: VEEGUM® R.T. Vanderbilt Company, Inc, USA), bentonite, and talcum. A composition of the invention may also comprise two or more different fillers.

Examples of suitable dispersing agents include, but are not limited to sulfonated aromatic polymer (commercial product MORWET D-425® Akzo Nobel), Ethylene Oxide/Propylene Oxide Block Copolymer (commercial product: PLURONIC P® BASF) and organosilicones (e.g. SILWET L-77® Helena chemical company. A composition of the invention may also comprise two or more different dispersing agents.

A preferred composition according to the invention,preferably a suspension, comprises 20 (w/w) % to 85% phosphite, more preferable 30% to 75% phosphite, more preferable 40% to 65% phosphite.

A preferred composition according to the invention comprises more than 15% lignin compounds such as from about 15% to about 60% lignin compounds, more preferably more than 20% such as from about 20% to about 50% lignin compounds, from about 20% to about 40% lignin compounds, from about 25% to about 30% lignin compounds, such as, for example, about 25%, about 26%, about 27%, about 28%, 29% or about 30% lignin compounds. A most preferred composition according to the invention comprises about 28 (w/w) % lignin compounds.

The relative amount of phosphite:lignin compound in a composition of the invention is preferably between 4:1 and 1:4 (w/w); more preferred between 3:1 and 1:3 (w/w), more preferred between 2:1 and 1:2 (w/w).

A preferred composition according to the invention may additionally comprise up to 20% of one or more wetting agents, more preferred up to 10%, more preferred up to 5% of one or more wetting agents. A most preferred composition according to the invention additionally comprises about 3% of one or more wetting agents.

A composition according to the invention may additionally comprise up to 20% of one or more spreaders, more preferred up to 10%, more preferred up to 5% of one or more spreaders. A most preferred composition according to the invention additionally comprises about 3% of one or more spreaders.

A composition according to the invention may additionally comprise up to 20% of one or more spreader/stickers, more preferred up to 10%, more preferred up to 5% of one or more spreader/stickers. A most preferred composition according to the invention additionally comprises about 3% of one or more spreader/stickers.

A composition according to the invention may additionally comprise up to 20% of one or more spreader/penetrants, more preferred up to 10%, more preferred up to 5% of one or more spreader/penetrants. A most preferred composition according to the invention additionally comprises about 3% of one or more spreader/penetrants.

The invention further provides the use of a lignin compound to reduce the phytotoxicity of a phosphite compound in a composition also containing a surfactant-type pesticide adjuvant.

The invention further provides a method of reducing the phytotoxicity of a composition comprising a phosphite compound, comprising adding a lignin compound to the composition. Said composition preferably is a fungicidal or plant fertilizing composition. A method of the invention will reduce the phytotoxicity of the composition comprising a phosphite compound at least twofold, more preferred at least threefold, more preferred at least fivefold, more preferred at least tenfold.

The invention further provides a method for protecting an agricultural plant from a plant disease, preferably a fungal disease, the method comprising applying to said agricultural plant a composition according to the invention, comprising a phosphite compound, a lignin compound and a pesticide adjuvant. Said composition may further comprise a suitable antifungal compound or a suitable pesticide.

Said agricultural plant is preferably a vegetable, fruit or crop plant. Said plant disease is preferably a disease that is caused by a pathogen. Said pathogen preferably is a fungus. Said fungus preferably belongs to the order Oomycetes (esp. Phytophthora sp., Plasmopara viticola (downy mildew).

A composition according to the invention may be diluted to a ready to use concentration of between 1 and 30 grams of phosphite/liter, more preferred between 5 and 20 gram/liter, most preferred about 10 gram/liter.

The invention further provides a method of producing a composition comprising a phosphite compound and an adjuvant with reduced toxicity, the method comprising adding a lignin compound to the composition. In a preferred method, the amount of a lignin compound is preferably more than 15% (w/w).

The verb “to comprise” and its conjugations as used in this description and in the claims is used in its non-limiting sense to mean that items following the word are included, but items not specifically mentioned are not excluded. In addition, reference to an element by the infinite article “a” or “an” does not exclude the possibility that more than one of the elements are present, unless the context clearly requires that there is one and only one of the elements. The indefinite article “a” or “an” thus usually means “at least one”.

The following examples are given for purely illustrative and non-limiting purposes for the present invention.

### EXAMPLES

### Example 1

Effect of Calcium Lignosulfonate on Phytotoxicity of a Composition of Potassium Phosphite with Various Adjuvants Towards Garden Cress (Lepidium sativum) Seedlings.

Two compositions of potassium phosphite are prepared, one with and one without calcium lignosulfonate (Borresperse CA®, Borregaard LignoTech Ltd, Germany). The formulation of the compositions is given in Table 1. The formulation and the concentration in the spray solution are calculated in such a way that the dosage of phosphite is the same for both compositions (120 mM=14.4 g potassium phosphite/1 spray solution). A control is added in which the adjuvants alone (without lignosulfonate or phosphite) are tested.

TABLE 1
Recipe and dosage of composition 1 and 2.

| | Comp. 1 | Comp. 2 | |
|---|---|---|---|
| KH2PO3 | 692 | 972 | g/kg |
| K2CO3 | 20 | 28 | g/kg |
| Ca-Lignosulfonate | 288 | 0 | g/kg |
| | 20.8 | 14.8 | g/l spray solution |

Various adjuvants are added to the two compositions: alcohol ethoxylate (commercial product: Genapol EP 2584, Clariant, Germany), di-octyl sulfosuccinate (commercial product Emulsogen SF8, Clariant, Germany), quaternary ammonium surfactant (commercial product Geronol CF/PN-20N, Rhodia, France) and ethoxylated tallow amine (commercial product Ethomeen S25, Akzo Nobel, The Netherlands). All adjuvant products arc added at a concentration of 5 g/l spray solution. For both compositions, a control is added without adjuvant.

Garden cress seedlings are grown in plastic boxes (100 seeds/box) on mineral sand. Boxes were kept at 22° C. One week old seedlings are sprayed with the various spray solutions until run-off of the solutions occurs. Phytotoxicity is observed three days after spraying. The percentage of seedlings dead or showing phytotoxicity symptoms is estimated. The experiment was carried out in a randomized block design with four replications.

Data analysis was performed on arcsine-transformed percentage data. The data are subjected to analysis of variance and Fisher's Least Significant Difference test.

The results of the experiment are presented in Table 2.

TABEL 2
Effect of Ca-lignosulfonate and various adjuvants on phytotoxicity
(% of seedlings dead or showing symptoms) of potassium
phosphite towards garden cress seedlings

| | Composition 1 | | Composition 2 | | | |
|---|---|---|---|---|---|---|
| | With | | Without | | Control 2 | |
| | Ca-lignosulfonate | | Ca-lignosulfonate | | water | |
| Genapol EP 2584 | 10 | C¹ | 95 | D | 10 | C |
| Emulsogen SF8 | 10 | C | 95 | D | 10 | C |
| Geronol CF/PN-20N | 10 | C | 95 | D | 10 | C |
| Ethomeen S25 | 10 | C | 95 | D | 10 | C |
| Control 1 | 0 | A | 50 | B | n.a. | |

¹Means with a different letter are significantly different (p < 0.05, Fisher's LSD).

The experiment shows that potassium phosphite is phytotoxic towards garden cress seedlings. The adjuvants by themselves show only low phytotoxicity. The various adjuvants increase the phytotoxicity of phosphite. However, calcium lignosulfonate reduces the phytotoxicity of phosphite without adjuvants and even stronger in combination with adjuvants.

### Example 2

Effect of Sodium Lignosulfonate on Phytotoxicity of a Composition of Potassium Phosphite with Various Adjuvants Towards Rose (Cultivar xxxx).

The experimental design is a randomized block design with a plot size of 3 plants per plot. The experiment has 4 replications. Plants are sprayed with solution until run-off occurs. The composition and the dose rate of the different treatments are the same as in example 1, except that calcium lignosulfonate was replaced by sodium lignosulfonate (Borresperse NA®, Borregaard LignoTech Ltd, Germany).

Phytotoxicity is observed one week after spraying. Per plant, the percentage leaf area dead or showing phytotoxicity symptoms is estimated. The results of the experiment are presented in Table 3.

TABEL 3
Effect of Sodium lignosulfonate and various adjuvants on
phytotoxicity (% of leaf area dead or showing symptoms)
of potassium phosphite towards rose.

| | Composition 1 | | Composition 2 | | | |
|---|---|---|---|---|---|---|
| | With | | Without | | Control 2 | |
| | Na-lignosulfonate | | Na-lignosulfonate | | water | |
| Genapol EP 2584 | 10 | c¹ | 95 | D | 10 | C |
| Emulsogen SF8 | 10 | C | 95 | D | 10 | C |
| Geronol CF/PN-20N | 10 | C | 95 | D | 10 | C |
| Ethomeen S25 | 10 | C | 95 | D | 10 | C |
| Control 1 | 0 | A | 50 | B | n.a. | |

The experiment shows that potassium phosphite is phytotoxic towards rose. The adjuvants by themselves show only low phytotoxicity. The various adjuvants increase the phytotoxicity of phosphite. However, sodium lignosulfonate reduces the phytotoxicity of phosphite without adjuvants and even stronger in combination with adjuvants.

### Example 3

Effect of Calcium Lignosulfonate on Phytotoxicity of a Composition of Potassium Phosphite with Various Adjuvants Towards Grapevine Cultivar Merlot

The experimental design is a randomized block design with a plot size of 3 plants per plot. The experiment has 4 replications. Plants are sprayed with solution until run-off occurs. The composition and the dose rate of the different treatments are the same as in example 1.

Phytotoxicity is observed one week after spraying. Per plant, the percentage leaf area dead or showing phytotoxicity symptoms was estimated. The results of the experiment are presented in Table 4.

TABEL 4
Effect of Calcium lignosulfonate and various adjuvants on phytotoxicity
(% of leaf area dead or showing symptoms) of potassium phosphite
towards grapevine cultivar Merlot.

| | Composition 1 | | Composition 2 | | | |
|---|---|---|---|---|---|---|
| | With | | Without | | Control 2 | |
| | Na-lignosulfonate | | Na-lignosulfonate | | water | |
| Genapol EP 2584 | 10 | c¹ | 95 | D | 10 | C |
| Emulsogen SF8 | 10 | C | 95 | D | 10 | C |
| Geronol CF/PN-20N | 10 | C | 95 | D | 10 | C |
| Ethomeen S25 | 10 | C | 95 | D | 10 | C |
| Control 1 | 0 | A | 50 | B | n.a. | |

¹Means with a different letter are significantly different (p < 0.05, Fisher's LSD).

The experiment shows that potassium phosphite is phytotoxic towards grapevine. The adjuvants by themselves show only low phytotoxicity. The various adjuvants increase the phytotoxicity of phosphite. However, sodium lignosulfonate reduces the phytotoxicity of phosphite without adjuvants and even stronger in combination with adjuvants.

### Example 4

Effects of Sodium Lignosulfonate on Phytotoxicity of a Composition Comprising Potassium Phosphite and Various Adjuvants Towards Rose (Cultivar Vendela).

The experimental design was a randomized block design with a plot size of 3 plants per plot. The experiment had 4 replications. Plants were sprayed with solution until run-off occurred. The compositions and the dose rate of the different treatments were the same as in example 1, except that calcium lignosulfonate was replaced by sodium lignosulfonate (Borresperse NA®, Borregaard LignoTech Ltd, Germany).

Phytotoxicity was observed after four sprays given in a weekly interval. In the first two sprays the products were sprayed as indicated in example 1. In the third spray, the concentration of the product was doubled. In the fourth spray, the concentration was quadrupled. Phytotoxicity was scored on an arbitrary scale of 1 to 9 (1 is no phytotoxicity symptoms and 9 is 100% of the plant suffering from phytotoxicity. General results (ANOVA) Test by Duncan (α=0.05).

The results of the experiment are presented in Table 5.

The results show that the adjuvants alone (control 2) and the formulations without sodium-lignosulfonate induce more phytotoxicity than the corresponding phosphite formulations with sodium-lignosulfonate.

TABLE 5
Effect of sodium lignosulfonate on phosphite formulations (composition 1
and 2, see example 1) containing different surfactants. Control 1 is the phosphite
formulation without surfactants; control 2 is only the surfactant without the
phosphite formulations.

| | Composition 1 | | Composition 2 | | | |
|---|---|---|---|---|---|---|
| | with | | without | | | |
| | Na-lignosulfonate | | Na-lignosulfonate | | Control 2 | |
| | Mean | | Mean | | Mean | |
| Pesticide | phytotoxicity | | phytotoxicity | | phytotoxicity | |
| adjuvant | score | Significance¹ | score | Significance | score | Significance |
| Emulsogen | 1.637 | ced | 1.938 | b | 1.828 | cb |
| SF8 | | | | | | |
| Geronol | 1.787 | cb | 2.016 | b | 1.833 | cb |
| CF/PN- | | | | | | |
| 20N | | | | | | |
| Ethomeen | 1.454 | fe | 1.974 | b | 1.75 | cbd |
| S25 | | | | | | |
| Control 1 | 1.499 | fed | 1.368 | cb | 1.325 | f |

¹Means with a different letter are significantly different (p < 0.05, Fisher's LSD).

1. A composition comprising a phosphite compound, a lignin compound and a pesticide adjuvant, comprising an amount of said lignin compound of more than 15% (w/w).

2. The composition of claim 1, wherein the amount of phosphite compound is between 20 w/w % to 85 w/w %.

3. The composition of claim 1, wherein the amount of lignin compound is between 15 w/w % to 60 w/w %.

4. The composition according to claim 1, wherein said pesticide adjuvant is selected from a wetting agent, a spreader, a spreader/sticker, a spreader/penetrant, and combinations thereof.

5. The composition according to claim 1, wherein the composition is a fungicide.

6. The composition according to claim 1, wherein the composition is a plant fertilizer.

7-8. (canceled)

9. A method of reducing the phytotoxicity of a composition comprising a phosphite compound and an adjuvant, said method comprising adding a lignin compound to the composition.

10. The method of claim 9, wherein the composition is a fungicidal composition.

11. The method of claim 9, wherein the composition is a plant fertilizing composition.

12. A method for protecting an agricultural plant from a plant disease comprising applying to said agricultural plant a composition according to claim 1.

13. A method of producing a composition comprising a phosphite compound and an adjuvant with reduced toxicity, the method comprising adding a lignin compound to the composition.

14. The method according to claim 13, wherein the amount of a lignin compound is more than 15% (w/w).

15. The method of claim 12 wherein the disease is a fungal disease.

16. A method to fertilize an agricultural plant which method comprises comprising applying to said agricultural plant a composition according to claim 1.

17. The composition according to claim 2, wherein the composition is a fungicide.

18. The composition according to claim 1, wherein the composition is a plant fertilizer.

19. The composition according to claim 3, wherein the composition is a fungicide.

20. The composition according to claim 3, wherein the composition is a plant fertilizer.
